(19) United States
(12) Patent Application Publication
(10) Pub. No.: US 2018/0062482 A1
(43) Pub. Date: Mar. 1, 2018

(54) Rotor Retaining Ring

(71) Applicant: General Electric Technology GmbH, Baden (CH)

(72) Inventors: Flavio Giardino, Dietikon (CH); Sayantan Bhar, Birr (CH)

(21) Appl. No.: 15/244,536

(22) Filed: Aug. 23, 2016

(51) Int. Cl. H02K 9/04

(52) U.S. Cl. CPC H02K 9/04

(57) ABSTRACT

The present application provides a dynamoelectric machine. The dynamoelectric machine may include a stator, a rotor, and an air gap separating the stator and the rotor. The rotor may include a rotor retaining ring. The rotor retaining ring may include a slanted length extending along the air gap.

### TECHNICAL FIELD

The present application and the resultant patent relate generally to dynamoelectric machines such as generators used in the production of electrical power and more particularly relate to an improved rotor retaining ring for increasing air gap air flow volume for an increase in overall efficiency.

### BACKGROUND OF THE INVENTION

Generally described, large turbine driven generators used in the production of electrical power and the like may include a rotor that serves as a source of magnetic lines of flux produced by a wound coil carried on the rotor. The rotor rotates within a stator that may include a number of conductors in which an alternating current may be induced by the rotor as it rotates therein. This rotation generates a magnetic field in a narrow air gap between the stator and the rotor.

The overall power output of a generator may be limited by the ability to provide additional current due to a buildup of heat in the stator components and/or the rotor components. Such a buildup of heat may be compensated for by the use of oversize fans and the like. Such oversize fans, however, may represent a parasitic loss so as to reduce overall system output and efficiency.

### SUMMARY OF THE INVENTION

The present application and the resultant patent thus provide an improved dynamoelectric machine. The improved dynamoelectric machine may include a stator, a rotor, and an air gap separating the stator and the rotor. The rotor may include a rotor retaining ring. The rotor retaining ring may include a slanted length extending along the air gap.

The present application and the resultant patent further may provide a method of operating a dynamoelectric machine. The method may include the steps of rotating a rotor within a stator with the rotor and the stator separated by an air gap, directing a cooling flow into the air gap, and axially directing the cooling flow into the air gap by a slanted length positioned about a retaining ring of the rotor.

The present application and the resultant patent further may provide a dynamoelectric machine. The dynamoelectric machine may include a stator, a rotor, and an air gap separating the stator and the rotor. The rotor may include a rotor retaining ring. The rotor retaining ring may include a radius and a slanted length extending along the air gap at a forward end thereof.

These and other features and improvements of the present application and the resultant patent may become apparent to one of ordinary skill in the art upon review of the following detailed description when taken in conjunction with the several drawings and the appended claims.

### BRIEF DESCRIPTION

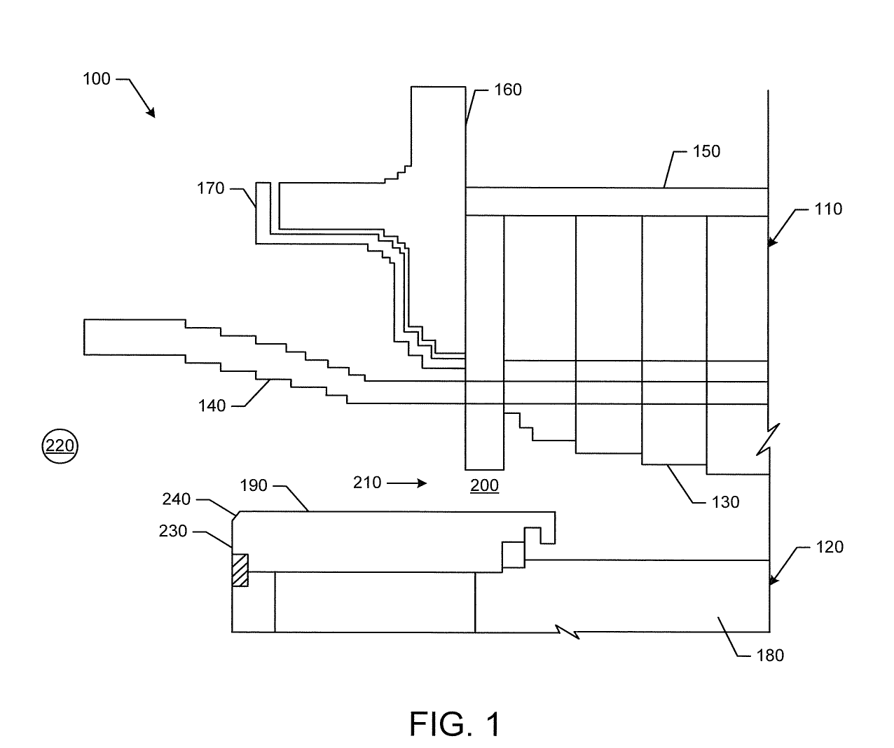

FIG. 1 is a schematic diagram of an electric generator with a stator and a rotor.

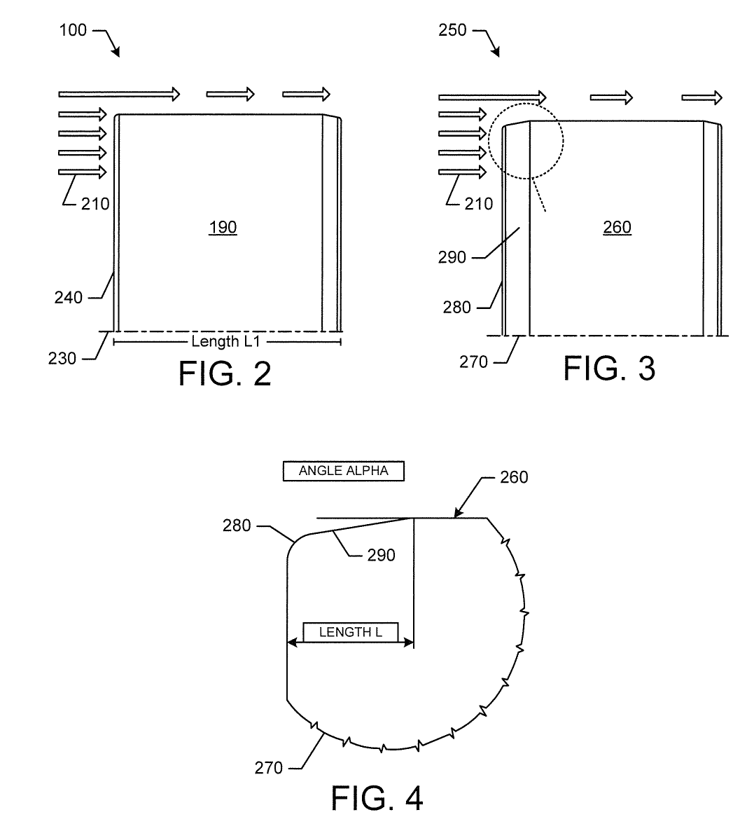

FIG. 2 is a partial plan view of a rotor retaining ring for use with the generator of FIG. 1.

FIG. 3 is a partial plan view of a rotor retaining ring for use with a generator as may be described herein.

FIG. 4 is a partial side view of the rotor retaining ring of FIG. 3.

### DETAILED DESCRIPTION

Referring now to the drawings, in which like numerals refer to like elements throughout the several views, FIG. 1 is a schematic diagram of an example of a dynamoelectric machine 100. The dynamoelectric machine 100 may include a stator 110 and a rotor 120. The stator 110 may have a generally annular shape that circumscribes the rotor 120 therein. The stator 110 may include a number of stator core bundles or packages 130. The stator core packages 130 may be formed of a low loss, low magnetic resistance material. A number of armature end windings 140 may extend outwardly from the stator core packages 130. A frame 150 may support the stator core packages 130. One or more stator flanges 160 may be used to axially compress the stator core packages 130. A stator flux shield 170 may surround the stator flange 160 in whole or in part. The stator 110 and the components thereof are described herein for the purpose of example only. Other components and configurations may be used herein.

The rotor 120 may include a number of conductor coils 180 therein. The conductor coils 180 may be positioned within a retaining ring 190. The retaining ring 190 maintains the conductor coils 180 in place despite the centrifugal forces created when the rotor 120 spins. The rotor 120 and the components thereof are described for the purpose of example only. Other components and other configurations may be used herein.

The stator 110 and the rotor 120 may be separated by an air gap 200. A cooling flow 210 may be created by a fan 220 or other type of air movement device and directed towards the air gap 200. The stator 110 and the components thereof may be cooled by the cooling flow 210 flowing through the air gap 200. Overall efficiency and output may be improved with an adequate cooling flow 210 reaching the stator 110 and the components thereof.

FIG. 2 shows an example of the rotor retaining ring 190. The rotor retaining ring 190 may have a length of L1. Length L1 may vary. As is shown, a forward end 230 may have a small radius 240 thereon. A chamfer and the like also may be used. Alternatively, a blunt end also may be used. Flow simulations have shown that the radius 240 of the retaining ring 190 may direct the cooling flow 210 away from its intended axial direction through the air gap 200. As a result, the cooling flow 210 through the air gap 200 may be limited with increased overall pressure drop.

FIGS. 3 and 4 show a portion of a dynamoelectric machine 250 as may be described herein. Specifically, a rotor retaining ring 260 is shown. Instead of simply the radius 240 at the forward end 230 as described above, the retaining ring 260 in this example includes at a forward end 270 a radius 280 followed by a slanted length 290. The slanted length 290 may extend at an Angle Alpha for a Length L. The Angle Alpha may vary from more than about zero degrees to less than about forty-five degrees. Other angles may be used herein. The Length L may extend along the Length L1. The Angle Alpha and the Length L may vary. The intersection of the slanted length 290 and remaining flat length of the retaining ring 260 also may have a smooth radius thereon so as to further improve the flow into the air gap 200. Other components and other configurations may be used herein.

The slanted length 290 of the retaining ring 260 thus faces the incoming cooling flow 210 from the fan 220. The slanted length 290 helps guide the cooling flow 210 into and through the air gap 200. The slanted length 290 of the rotor retaining ring 260 thus increases the volume of the cooling flow 210 into the air gap 200 so as to provide a decrease in the temperature of the stator components 110. The rotor retaining ring 260 thus efficiently guides the cooling flow 210 into the air gap 200 instead of disrupting the flow. Such a cooling flow 210 thus may increase overall system efficiency and output.

It should be apparent that the foregoing relates only to certain embodiments of the present application and the resultant patent. Numerous changes and modifications may be made herein by one of ordinary skill in the art without departing from the general spirit and scope of the invention as defined by the following claims and the equivalents thereof.

We claim:

1. A dynamoelectric machine, comprising:
a stator;
a rotor; and
an air gap separating the stator and the rotor;
the rotor comprising a rotor retaining ring;
the rotor retaining ring comprising a slanted length extending along the air gap.

2. The dynamoelectric machine of claim 1, wherein the rotor retaining ring comprises the slanted length at a forward end.

3. The dynamoelectric machine of claim 2, wherein the rotor retaining ring comprises a radius upstream of the slanted length at the forward end.

4. The dynamoelectric machine of claim 1, further comprising a fan positioned upstream of the stator.

5. The dynamoelectric machine of claim 4, wherein the fan provides a cooling flow.

6. The dynamoelectric machine of claim 5, wherein the slanted length guides the cooling flow axially into the air gap.

7. The dynamoelectric machine of claim 5, wherein the cooling flow cools the stator.

8. The dynamoelectric machine of claim 5, wherein the cooling flow cools a plurality of stator core packages.

9. The dynamoelectric machine of claim 1, wherein the slanted length comprises an Angle Alpha of about zero degrees (0°) to about forty-five degrees 45°).

10. The dynamoelectric machine of claim 1, wherein the slanted length comprises a Length L of up to about Length L1.

11. The dynamoelectric machine of claim 1, wherein the slanted length comprises an Alpha Angle of about zero degrees (0°) to about forty-five degrees) (45°) and a Length L of up to about Length L1.

12. A method of operating a dynamoelectric machine, comprising:
rotating a rotor within a stator;
the rotor and the stator separated by an air gap;
directing a cooling flow into the air gap; and
axially directing the cooling flow into the air gap by a slanted length positioned about a retaining ring of the rotor.

13. The method of claim 12, further comprising the step of cooling the stator with the cooling flow.

14. The method of claim 13, wherein the step of cooling the stator with the cooling flow comprises cooling a plurality of stator core packages with the cooling flow.

15. The method of claim 12, further comprising the step of positioning the slanted length about a forward end of the retaining ring.

16. A dynamoelectric machine, comprising:
a stator;
a rotor; and
an air gap separating the stator and the rotor;
the rotor comprising a rotor retaining ring;
the rotor retaining ring comprising a radius and a slanted length extending along the air gap at a forward end thereof.

17. The dynamoelectric machine of claim 16, further comprising a fan positioned upstream of the stator.

18. The dynamoelectric machine of claim 17, wherein the fan provides a cooling flow such that the slanted length guides the cooling flow axially into the air gap.

19. The dynamoelectric machine of claim 16, wherein the slanted length comprises an Angle Alpha of about zero degrees) (0°) to about forty-five degrees) (45°).

20. The dynamoelectric machine of claim 16, wherein the slanted length comprises a Length L of up to about Length L1.
